(19) United States
(12) Patent Application Publication
(10) Pub. No.: US 2019/0098824 A1
(43) Pub. Date: Apr. 4, 2019

(54) SYSTEMS AND METHODS FOR AN AGRICULTURAL IMPLEMENT HAVING PIVOTING STABILIZER WHEELS

(71) Applicant: CNH Industrial America LLC, Racine, WI (US)

(72) Inventor: Michael G. Kovach, Morton, IL (US)

(21) Appl. No.: 15/719,935

(22) Filed: Sep. 29, 2017

(51) Int. Cl. A01B 63/16; A01B 73/04

(52) U.S. Cl. CPC A01B 63/16; A01B 59/042; A01B 73/044

(57) ABSTRACT

An agricultural implement includes a floating hitch and a frame pivotally coupled to the floating hitch and having a front end and a back end. The agricultural implement further includes a plurality of main lift wheels coupled to the frame adjacent to the back end by a main adjustment mechanism, a pair of front wheels coupled to the main frame section adjacent to the front end thereof, and a pair of stabilizer wheels coupled to the frame by a stabilizer adjustment mechanism. The main adjustment mechanism is configured to control a vertical distance between the frame and the plurality of main lift wheels. The pair of front wheels are coupled to the main adjustment mechanism for vertical adjustment therewith. The stabilizer adjustment mechanism is configured to control a vertical distance between the pair of stabilizer wheels and the frame and is physically isolated from the main adjustment mechanism.

### CROSS REFERENCE TO RELATED APPLICATION

Not applicable.

### FIELD OF THE INVENTION

The present invention pertains to agricultural implements and, more specifically, to an agricultural implement having a tillage frame and stabilizer wheels arranged on pivotal wings of the tillage frame.

### BACKGROUND OF THE INVENTION

Many types of pull-type agricultural implements (e.g., discs, cultivators, plows, etc.) may be attached to and towed behind a work vehicle to perform a desired agricultural task. Some agricultural implements may include a frame with wing sections that extend from a central section and enable the implement to cover wide areas of ground. In some configurations, the frame of the implement may facilitate a pivotal, or floating, connection between the frame and the work vehicle. The pivotal connection between the frame and the work vehicle may enable the implement to follow the contour of the ground independently from the work vehicle. For example, the pivotal connection may allow the implement to follow the contour of the ground as the work vehicle travels over uneven sections of ground.

### SUMMARY OF THE INVENTION

Some embodiments of the invention provide an agricultural implement that includes a floating hitch, and a frame having a front end and a back end. The frame includes a main frame section pivotally coupled to the floating hitch at the front end thereof, a first wing section pivotally coupled to one side of the main frame section, and a second wing section pivotally coupled to another side of the main frame section opposite the first wing section. The agricultural implement further includes a plurality of main lift wheels coupled to the frame adjacent to the back end by a main adjustment mechanism, a pair of front wheels coupled to the main frame section adjacent to the front end thereof, and a pair of stabilizer wheels. One of the pair of stabilizer wheels is coupled to the first wing section adjacent to the front end thereof and another of the pair of stabilizer wheels is coupled to the second wing section adjacent to the front end thereof. The pair of stabilizer wheels are coupled to the frame by a stabilizer adjustment mechanism that is vertically adjustable independent from the main adjustment mechanism.

Some embodiments of the invention provide an agricultural implement that includes a floating hitch, a frame pivotally coupled to the floating hitch and having a front end and a back end, and a plurality of main lift wheels coupled to the frame adjacent to the back end by a main adjustment mechanism. The main adjustment mechanism is configured to control a vertical distance between the frame and the plurality of main lift wheels. The agricultural implement further includes a pair of front wheels coupled to the main frame section adjacent to the front end thereof, and a pair of stabilizer wheels coupled to the frame by a stabilizer adjustment mechanism. The pair of front wheels are coupled to the main adjustment mechanism for vertical adjustment therewith. The stabilizer adjustment mechanism is configured to control a vertical distance between the pair of stabilizer wheels and the frame, and the stabilizer adjustment mechanism is physically isolated from the main adjustment mechanism.

Some embodiments of the invention provide an agricultural implement that includes a floating hitch, and a frame pivotally coupled to the floating hitch and having a front end and a back end. The frame is vertically movable between a raised position and a lowered position via a main adjustment mechanism. The agricultural implement further includes a plurality of main lift wheels coupled to the frame adjacent to the back end by the main adjustment mechanism, a pair of front wheels coupled to the main frame section adjacent to the front end thereof, and a pair of stabilizer wheels coupled to the frame by a stabilizer adjustment mechanism. The pair of front wheels are coupled to the main adjustment mechanism. The stabilizer adjustment mechanism is configured to control a vertical distance between the pair of stabilizer wheels and the frame, and the vertical distance between the pair of stabilizer wheels and the frame is adjustable independent of the vertical movement of the frame between the raised position and the lowered position.

### BRIEF DESCRIPTION OF THE DRAWINGS

For the purpose of illustration, there are shown in the drawings certain embodiments of the present invention. It should be understood, however, that the invention is not limited to the precise arrangements, dimensions, and instruments shown. Like numerals indicate like elements throughout the drawings. In the drawings:

FIG. 1 illustrates a top, front, left isometric view of an agricultural implement, in accordance with an embodiment of the present invention;

FIG. 2 illustrates a top view of the agricultural implement of FIG. 1, in accordance with an embodiment of the present invention;

FIG. 3 illustrates a front view of the agricultural implement of FIG. 1 with a first wing section in a pivoted, transport position, in accordance with an embodiment of the present invention;

FIG. 4 illustrates a top, front, left isometric view of a stabilizer wheel of the agricultural implement of FIG. 1, in accordance with an embodiment of the present invention, in accordance with an embodiment of the present invention;

FIG. 5 illustrates a left side view of the agricultural implement of FIG. 1 in a raised position, in accordance with an embodiment of the present invention;

FIG. 6 illustrates a left side view of the agricultural implement of FIG. 1 in a lowered position, in accordance with an embodiment of the present invention.

### DETAILED DESCRIPTION OF THE INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

As used herein, unless otherwise specified or limited, the phrases “at least one of A, B, and C,” “one or more of A, B, and C,” and the like, are meant to indicate A, or B, or C (individually or plurally), or any combination of A, B, and/or C (individually or plurally), including one or more instances of A, one or more of instances B, and/or one or more of instances of C.

Currently, pull-type agricultural implements that utilize a floating hitch pivotally attached to a frame are designed with several front wheels to provide support at the front of every section of the frame. The front wheels are typically coupled to main lift wheels such that the front wheels displace relative to the frame in unison with the main lift wheels. In other words, a vertical distance between the main lift wheels and the frame may remain equal to a vertical distance between the front wheels and the frame even during changes in frame height (e.g., as the frame is raised or lowered). For example, the front wheels may be hydraulically coupled to the main lift wheels (i.e., receive a similar flow of fluid from the same fluid source as the main lift wheels). Alternatively or additionally, the front wheels may be mechanically coupled (e.g., via a plurality of linkages) to the main lift wheels. Thus, the coupling between the main lift wheels and the front wheels can add complexity and cost to the implement, and increase stress on the frame in the wheel areas.

Generally, embodiments of the invention provide an agricultural implement that provides structural support to the front of each frame section, while reducing the complexity and cost of manufacture and reduces stress on the frame. In this regard, some embodiments of the invention may include a frame having a main frame section and wing frame sections pivotally attached to opposing sides of the main frame section, where each of the wing frame sections includes at least one stabilizer wheel that is configured to be individually adjustable relative to the frame (i.e., adjustable relative to the frame in a manner that is decoupled from main lift wheels). For example, some embodiments may include a stabilizer wheel arranged on each of the wing frame sections that include a vertical adjustment mechanism that is physically, or functionally, isolated from a vertical adjustment mechanism of the main lift wheels. That is, a vertical adjustment mechanism of the stabilizer wheels is separate from and independently adjustable with respect to a vertical adjustment mechanism of the main lift wheels. In this way, for example, the agricultural implement may eliminate the need for added complexity and cost inherent to coupling all of the front wheels to the main lift wheels for vertical adjustment therewith. In addition, the stabilizer wheels may provide support to the frame, when the frame is in a lowered position and the implement is performing its desired agricultural task, without the need to be coupled to the adjustment mechanism of the main lift wheels.

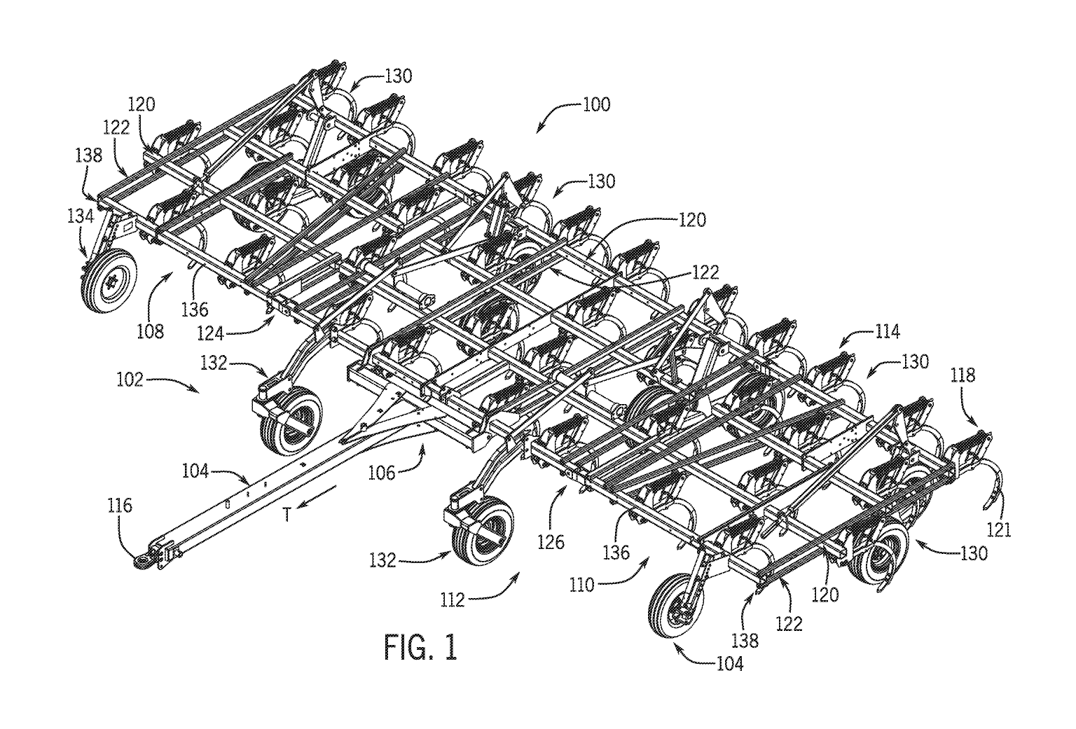

FIG. 1 illustrates an agricultural implement 100 according to one embodiment of the present invention. In the illustrated embodiment, for example, the agricultural implement 100 may be in the form of a chisel plow. However, the systems and methods disclosed herein may be applicable to other agricultural implements having a floating hitch pivotally attached thereto (e.g., a cultivator, vertical tillage, disc harrows, etc.).

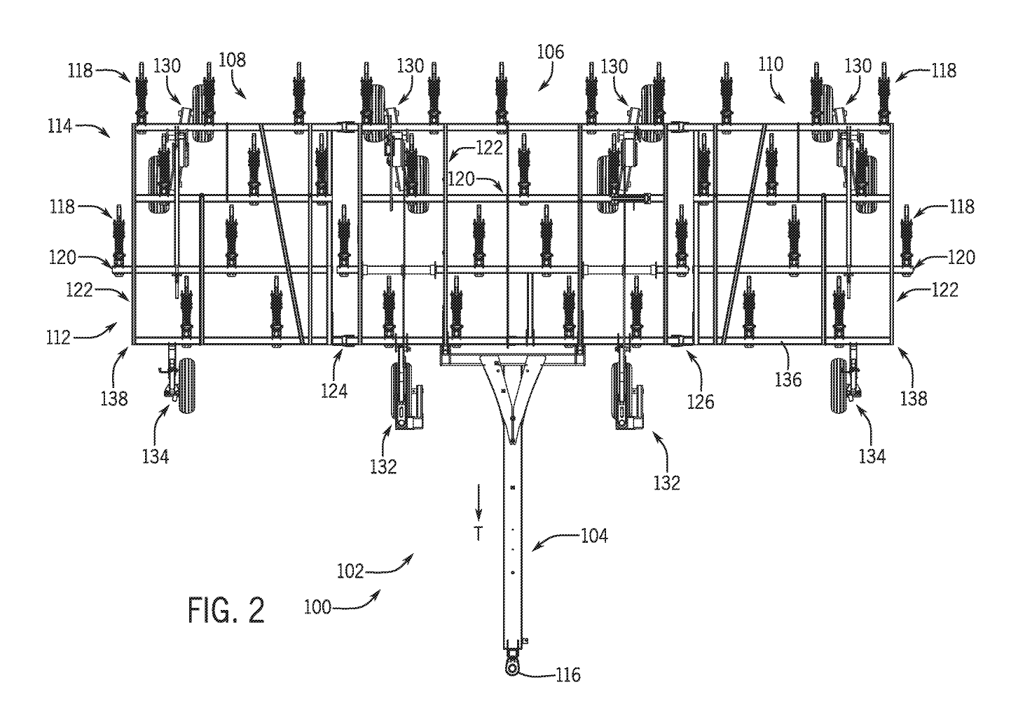

As illustrated in FIGS. 1 and 2, the agricultural implement 100 includes a frame 102 and a floating hitch 104 pivotally attached to the frame 102. The frame 102 may comprise a main frame section 106, a first wing section 108, a second wing section 110, a front end 112 and a back end 114. The floating hitch 104 may be pivotally attached to the front end 112 of the main frame section 106, and may generally extend away from the front end 112 of the main frame section 106 in a direction substantially parallel to a travel direction T. A distal end of the floating hitch 104 includes a coupling feature 116 to facilitate the coupling of the agricultural implement 100 to a work vehicle (e.g., a tractor).

Each of the main frame section 106, the first wing section 108, and the second wing section 110 includes a plurality of frame rods 120 and a plurality of support members 122. The plurality of frame rods 120 extend laterally across the respective sections 106, 108, and 110 of the frame 102 and are arranged at various locations between the front end 112 and the back end 114. In the illustrated embodiment, for example, each of the main frame section 106, the first wing section 108, and the second wing section 110 includes four frame rods 120 extending laterally thereacross. In some embodiments, for example, the main frame section 106, the first wing section 108, and/or the second wing section 110 may include more or less than four frame rods 120 arranged in any orientation, as desired.

The plurality of support members 122 extend generally transverse to the plurality of frame rods 120 (i.e., between the front end 112 and the back end 114) and are arranged at various locations laterally along the respective sections 106, 108, and 110 of the frame 102. In this way, for example, the plurality of frame rods 120 and the plurality of support members 122 form a generally crosshatch pattern within each section 106, 108, and 110 of the frame 102. It should be appreciated that the geometric design of the frame 102 is not meant to be limiting in any way, and the systems and methods described herein may be applied to another frame design with a floating hitch.

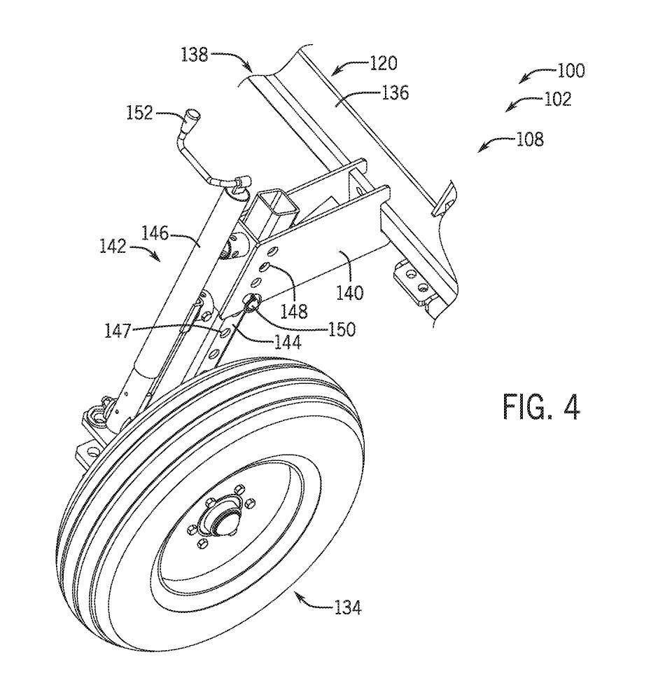

Generally, the frame 102 includes a plurality of shank assemblies 118 arranged at various locations thereon that enable the agricultural implement 100 to perform a desired agricultural task. In the illustrated embodiment, the plurality of shank assemblies 118 enable the agricultural implement 100 to break up and mix soil in an agricultural application, when the frame 102 is in an lowered position, as will be described below. Each of the shank assemblies 118 includes a shank 121 that defines a generally arcuate profile and extends downward (from the perspective of FIG. 4) toward the ground on which the agricultural implement 100 is configured to travel along. In some embodiments, for example, each of the plurality of shank assemblies 118 may include a spring, or damping element, that is configured to hold the shank 121 in contact with the ground and absorb shock when obstacles are encountered (e.g., hard ground or rocks).

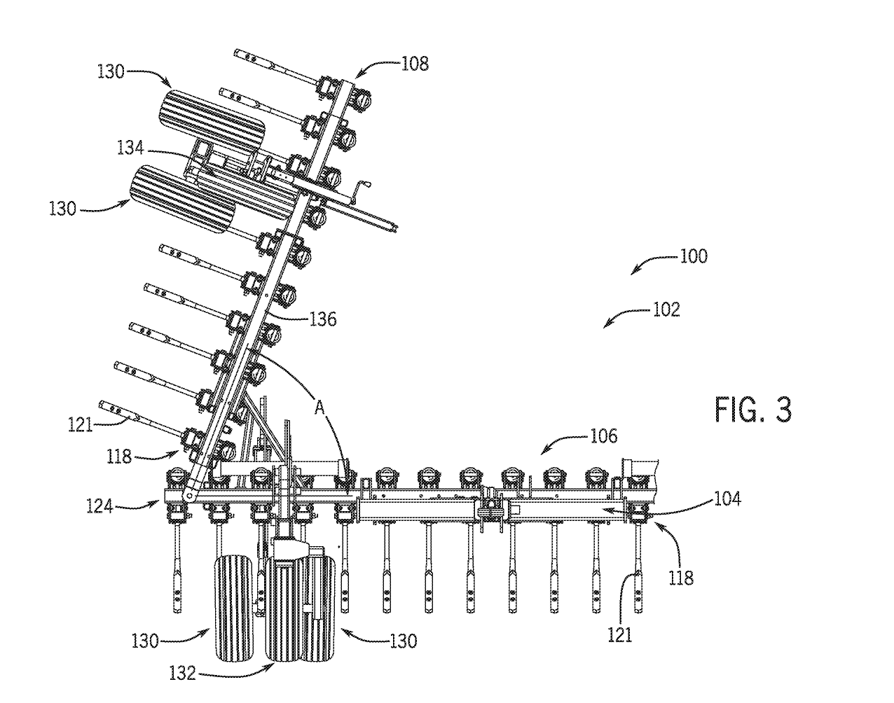

With reference to FIGS. 1-3, the first wing section 108 may be pivotally attached to a first side 124 of the main frame section 106 and the second wing section 110 may be pivotally attached to a second side 126 of the main frame section 106, which is laterally opposite to the first side 118. In general, the pivotal coupling of the first wing section 108 and the second wing section 110 to opposing sides of the main frame section 106 enables the frame 102 to be pivotally movable between a transport position (FIG. 3) and a working position (FIGS. 1 and 2). It should be appreciated that, although only the first wing section 108 is illustrated in the transport position, the second wing section 110 is configured to by symmetrically pivoted like the first wing section 108 in the transport position.

In the transport position (FIG. 3), the first wing section 108 and the second wing section 110 are pivotally rotated relative to the main frame section 106, such that the first wing section 108 and the second wing section 110 are arranged generally above the main frame section 106 with an angle A formed therebetween. In some embodiments, for example, the angle A may be between approximately 10 degrees and approximately 80 degrees. In the working position (FIGS. 1 and 2), the first wing section 108 and the second wing section 110 may be generally aligned in a common plane with the main frame section 106, which may be generally parallel to the ground on which the agricultural implement 100 travels.

A transition from the working position to the transport position enables the agricultural implement 100 to define a reduced lateral footprint. For example, in the transport position, a lateral width of the main frame section 106 (i.e., a width defined in a direction transverse to the travel direction T) may define the lateral footprint of the agricultural implement 100. This reduced lateral footprint may facilitate the transport of the agricultural implement 100, for example, along a road without blocking other traffic. In addition, with only the main frame section 106 in engagement with the ground during transport, the agricultural implement 100 may provide reduced friction during travel, thereby applying less load on the work vehicle transporting the agricultural implement 100.

In some embodiments, for example, the transition between the working position and the transport position may be an automated, or semi-autonomous process via, mechanical, electrical, and/or hydraulic assistance. In these embodiments, an operator may be able to selectively control the transition between the transport position and the working position, for example, via a control mechanism within an operator compartment of the work vehicle. In some embodiments, for example, the transition between the working position and the transport position may be a manual process, or a process that is assisted via a lifting mechanism that is external to the agricultural implement 100 and the work vehicle (e.g., a lift or crane-type device).

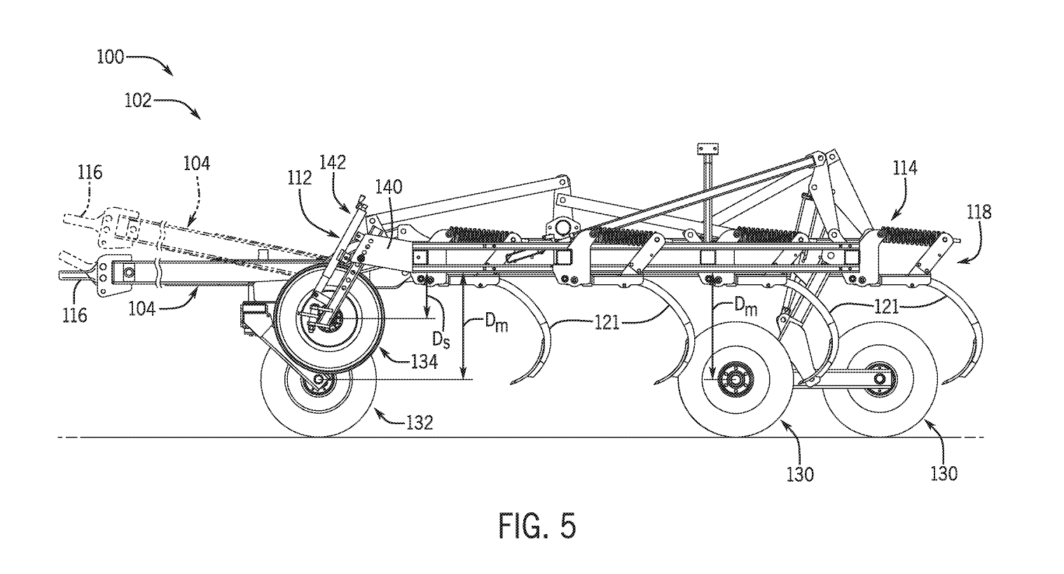

Generally, from the working position, the frame 102 is movable in a vertical direction (from the perspective of FIG. 5) toward and away from the ground on which the agricultural implement 100 travels. This vertical adjustability of the frame 102 may be facilitated by a vertical adjustment mechanism that couples the frame 102 to a selective group of wheels that support the frame 102. In the illustrated embodiment, the agricultural implement 100 may include a plurality of main lift wheels 130, a pair of front wheels 132, and a pair of stabilizer wheels 134. Each of the plurality of main lift wheels 130, a pair of front wheels 132, and a pair of stabilizer wheels 134 is attached to the frame 102 to support various portions thereof and enable the agricultural implement 100 to travel (i.e., be towed) by a work vehicle. The plurality of main lift wheels 130 provide support to the back end 114 of the frame 102, while the pair of front wheels 132 and the pair of stabilizer wheels 134 may provide support to the front end 112 of the frame 102.

In the illustrated embodiment, for example, two pairs of the plurality of main lift wheels 130 are arranged on the opposing sides 124 and 126 of the main frame section 106, one pair of the plurality of main lift wheels 130 is arranged on the first wing section 108, and one of the plurality of main lift wheels 130 is arranged on the second wing section 110. Thus, the back end 114 of the frame 102 is supported at each section 106, 108, and 110 by at least one pair of the main lift wheels 130. It should be appreciated that the number and grouping of the main lift wheels 130 of the illustrated agricultural implement 100 are not meant to be limiting in any way and, in other embodiments, for example, the agricultural implement 100 may include more or less main lift wheels 130 as long as the back end 114 of the frame 102 is properly supported.

As described herein, the utilization of a floating hitch necessitates the need to support the front of a center frame on an agricultural implement, for example, to prevent a teeter-totter effect as the work vehicle travels over uneven ground. In the illustrated embodiment, for example, one of the pair of front wheels 132 are arranged on each side 124 and 126 of the main frame section 106 to support the front end 112 thereof. Each of the first wing section 108 and second wing section 110 includes one of the pair of stabilizer wheels 134. The pair of stabilizer wheels 134 may be configured to selectively provide support to the first wing section 108 and the second wing section 110. In some embodiments, as will be described below, the pair of stabilizer wheels 134 may be configured to only engage the ground, and thereby provide support to the front end 112 of the first wing section 108 and the second wing section 110, when the frame 102 is in a lowered position and the agricultural implement 100 is performing its desired agricultural task (e.g., breaking and mixing up soil via the shanks 121).

It should be appreciated that the following discussion of the stabilizer wheel 134 coupled to the first wing section 108 similarly applies to the other stabilizer wheel 134 coupled to the second wing section 110. Turning to FIGS. 1-4, the stabilizer wheel 134 may be coupled to one of the plurality of frame rods 120 of the first wing section 108. In the illustrated embodiment, for example, the stabilizer wheel 134 is attached to a front rod 136 of the plurality of frame rods 120 that is arranged on the front end 112 of the frame 102. The stabilizer wheel 134 may be arranged adjacent to an outer edge 138 of the first wing section 108 (i.e., a side of the first wing section 108 opposite to the side pivotally coupled to the main frame section 106). In some embodiments, for example, the stabilizer wheel 134 may be coupled to the front rod 136 at a lateral location between the outer edge 138 and pivotal junction between the first wing section 108 and the main frame section 106. In the illustrated embodiment, for example, the lateral location of the stabilizer wheel 134 along the front rod 136 may be closer to the outer edge 138 than to the pivotal junction between the first wing section 108 and the main frame section 106.

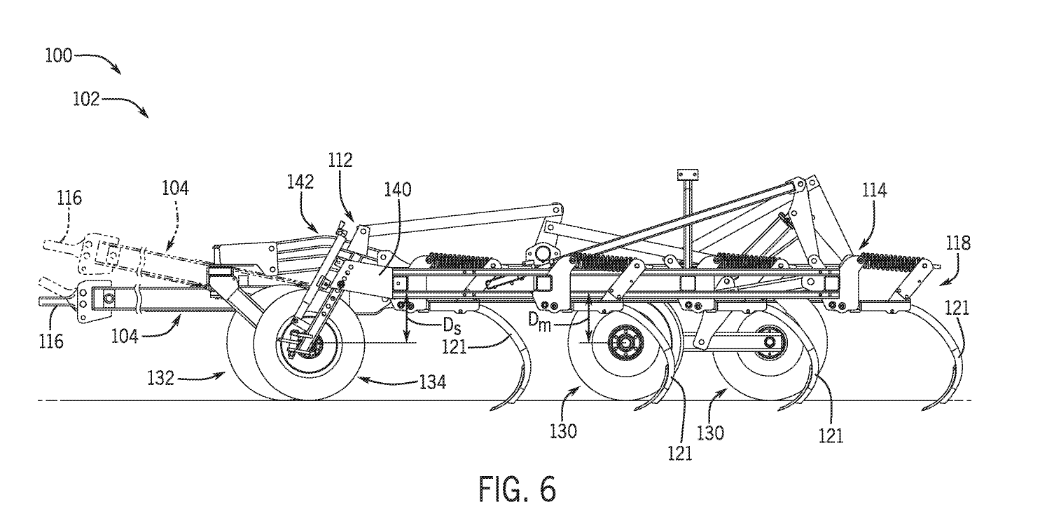

The stabilizer wheel 134 may be coupled to the front rod 136 by a bracket 140 and a stabilizer adjustment mechanism 142. In the illustrated embodiment, the bracket 140 extends from the front rod 136 generally in the travel direction T. The stabilizer adjustment mechanism 142 may be coupled to a distal end of the bracket 140. Generally, the stabilizer adjustment mechanism 142 may be configured to selectively control a vertical distance Dₛ (see FIGS. 5 and 6) between the stabilizer wheel 134 and the frame 102. The stabilizer adjustment mechanism 142 is physically isolated from the plurality of main lift wheels 130 and the pair of front wheels 132, such that the stabilizer wheels 134 are independently adjustable. In the illustrated embodiment, for example, the stabilizer adjustment mechanism 142 may include a support tube 144 and a screw jack 146. The support tube 144 may be slidably received within the distal end of the bracket 140 and may include a plurality of holes 147 arranged longitudinally therealong and extending laterally therethrough. A distal end of the bracket 140 may include a plurality of bracket holes 148 configured to correspond with the plurality of holes 147 in the support tube 144 to enable a pin 150 to extend therethrough. The pin 150 may be configured to rigidly couple the support tube 144, and thereby the stabilizer wheel 134, to the bracket 140.

The screw jack 146 may be coupled to the bracket 140 and to the support tube 144 at opposing ends thereof. For example, the screw jack 146 may be coupled to the bracket 140 at an upper end thereof and to the support tube 144 at a lower end thereof. In the illustrated embodiment, the screw jack 146 includes a handle 152 that may be manipulated by an operator to vertically adjust a height of the stabilizer wheel 134. That is, the vertical distance Dₛ between the stabilizer wheel 134 and the frame 102 may be controlled via the manipulation of the handle 152. For example, the screw jack 146 may exhibit a telescopic displacement of a component arranged therein in response to rotation of the handle 152 in a given direction. In operation, for example, the vertical distance Dₛ may be set by removing the pin 150 and rotating the handle 152 in a desired direction to either increase or decrease the vertical distance Dₛ. Once the vertical distance Dₛ is set and at least one pair of the plurality of holes 147 aligns with the at least one pair of the plurality of bracket holes 148, the pin 150 may be inserted therethrough to rigidly couple the stabilizer wheel 134 to the bracket 140, and thereby to the frame 102.

It should be appreciated that the illustrated stabilizer adjustment mechanism 142 in the form of a screw jack 146 is not meant to be limiting in any way and, in other embodiments, another vertical adjustment mechanism that is physically isolated from the plurality of main lift wheels 130 and the pair of front wheels 132 may be implemented. In some embodiments, the stabilizer adjustment mechanism 142 may be in the form of an electric actuator, a hydraulic actuator, and/or an electrohydraulic actuator that is configured to be selectively actuated, for example, from an operator compartment of a work vehicle. In any case, the stabilizer adjustment mechanism 142 is configured to be physically isolated from a main adjustment mechanism that can control a vertical distance between the plurality of main lift wheels 130 and the frame 102. In some embodiments, for example, the stabilizer adjustment mechanism 142 may not include the screw jack 146 and one or more of the pins 150 may be utilized for vertical adjustment of the pair of stabilizer wheels 134.

General operation of the agricultural implement 100 will be described with reference to FIGS. 5 and 6. In operation, the agricultural implement 100 may be coupled to a work vehicle via the floating hitch 104 and the coupling feature 116. The pivotal coupling between the floating hitch 104 and the frame 102 is illustrated in FIGS. 5 and 6 using dashed lines. In some embodiments, for example, the coupling feature 116 may be pivotally coupled to a distal end of the floating hitch 104, as also illustrated using dashed lines in FIGS. 5 and 6. The pivotal functionality provided by the floating hitch 104 enables frame 102, and thereby the shank assemblies 118, to follow the contour of the ground, for example, as the work vehicle travels over uneven sections of ground.

In some applications, the agricultural implement 100 may be coupled to the work vehicle and transported, in the transport position, to a location to perform a desired agricultural task. The agricultural implement 100 may be transitioned from the transport position to the working position. From the working position, the frame 102 may be movable in a vertical direction (from the perspective of FIG. 5) toward and away from the ground on which the agricultural implement 100 travels. In particular, the frame 102 is movable between a raised position (FIG. 5) where the shanks 121 do not engage the ground and a lowered position (FIG. 6) where at least a portion of the shanks 121, preferably a distal end thereof, engage the ground to perform a desired agricultural task. In some embodiments, for example, the vertical displacement between the raised position and the lowered position may be facilitated via the main lift wheels 130. For example, the main lift wheels 130 may be hydraulically coupled to one another and to the frame 102 to facilitate the hydraulic raising and lowering of the frame 102. Alternatively or additionally, the main lift wheels 130 may be coupled to the frame 102 via one or more mechanical linkages configured to facilitate the selective raising and lowering of the frame 102. In any case, the main lift wheels 130 may be coupled to the frame 102 such that a main vertical adjustment mechanism enables an operator of a work vehicle, which is coupled to the agricultural implement 100 via the floating hitch 104, to selectively adjust the height of the frame 102 between the raised position and the lowered position.

In the illustrated embodiment, the pair of front wheels 132 may be physically coupled the main vertical adjustment mechanism of the plurality of main lift wheels 130. For example, the pair of front wheels 132 may be arranged within the same hydraulic circuit as the plurality of main lift wheels 130 such that they vertically displace in unison. Alternatively or additionally, the pair of front wheels 132 may be mechanically linked to the plurality of main lift wheels 130 (e.g., via one or more linkages). In any case, the pair of front wheels 132 and the plurality of main lift wheels 130 both utilize the main vertical adjustment mechanism and vertically adjust the frame 102 between the raised position and the lowered position in unison. That is, a vertical distance Dₘ between the plurality of main lift wheels 130 and the frame 102 may also be defined between the pair of front wheels 132 and the frame 102 as the frame 102 is adjusted between the raised position and the lowered position.

Contrary to the pair of front wheels 132, the stabilizer adjustment mechanism 142 of the pair of stabilizer wheels 134 is physically isolated from the main vertical adjustment mechanism that is coupled to the plurality of main lift wheels 130 and the pair of front wheels 132. In other words, the vertical distance Dₛ between the stabilizer wheels 134 and the frame 102 may be adjustable independent of the vertical distance Dₘ.

During operation, for example, the agricultural implement 100 may travel through a field in the working position. As the agricultural implement 100 travels through the field, an operator of the work vehicle may selectively transition the frame 102 between the raised position and the lowered position, where agricultural implement 100 performs its desired task (e.g., breaking up soil via the shanks 121). In the raised position, the plurality of main lift wheels 130 and the pair of front wheels 132 may engage the ground to support the frame 102. The coupling between the plurality of main lift wheels 130 and the pair of front wheels 132 via the main adjustment mechanism may ensure that the main frame section 106 is supported at all times during operation and transport.

Once the frame 102 is displaced to the lowered position via the main adjustment mechanism, the pair of stabilizer wheels 134 engage the ground and all of the plurality of main lift wheels 130, the pair of front wheels 132, and the pair of stabilizer wheels 134 may, for example, act to set a depth that a distal end of the shanks 121 extend into the ground. Thus, in the lowered position, the frame 102 is supported at the front end 112 of each section 106, 108, and 110 thereof. The support at each section 106, 108, and 110 of the frame 102, which may be necessitated by the pivotal coupling to the floating hitch 104, is accomplished without requiring the pair of stabilizer wheels 134 to be coupled to the main lift mechanism. This eliminates the need for added complexity and cost inherent to coupling the pair of stabilizer wheels 134 to the plurality of main lift wheels 130 for vertical adjustment therewith. In addition, the pair of stabilizer wheels 134 may provide support to the frame 102, when the frame 102 is in the lowered position and the agricultural implement 100 is performing its desired agricultural task, without the need to be coupled to the main adjustment mechanism of the plurality of main lift wheels 130.

These and other advantages of the present invention will be apparent to those skilled in the art from the foregoing specification. Accordingly, it is to be recognized by those skilled in the art that changes or modifications may be made to the above-described embodiments without departing from the broad inventive concepts of the invention. It is to be understood that this invention is not limited to the particular embodiments described herein, but is intended to include all changes and modifications that are within the scope and spirit of the invention.

What is claimed is:

1. An agricultural implement comprising:
a floating hitch;
a frame having a front end and a back end, the frame including:
a main frame section pivotally coupled to the floating hitch at the front end thereof;
a first wing section pivotally coupled to one side of the main frame section;
a second wing section pivotally coupled to another side of the main frame section opposite the first wing section; and
a plurality of main lift wheels coupled to the frame adjacent to the back end by a main adjustment mechanism;
a pair of front wheels coupled to the main frame section adjacent to the front end thereof; and
a pair of stabilizer wheels, wherein one of the pair of stabilizer wheels is coupled to the first wing section adjacent to the front end thereof and another of the pair of stabilizer wheels is coupled to the second wing section adjacent to the front end thereof, and
wherein the pair of stabilizer wheels are coupled to the frame by a stabilizer adjustment mechanism that is vertically adjustable independent from the main adjustment mechanism.

2. The agricultural implement of claim 1, wherein the frame is vertically movable between a raised position and a lowered position via the main adjustment mechanism.

3. The agricultural implement of claim 2, wherein movement between the raised position and the lowered position is independent of the vertical adjustment of the pair of stabilizer wheels via the stabilizer adjustment mechanism.

4. The agricultural implement of claim 2, wherein a transition between the raised position and the lowered position is configured to bring the pair of stabilizer wheels out of and into engagement with ground on which the agricultural implement is configured to travel.

5. The agricultural implement of claim 1, wherein the frame is configured to selectively transition between a working position and a transport position where the frame defines a reduced lateral footprint.

6. The agricultural implement of claim 5, wherein when the frame is in the transport position, the first wing section and the second wing section are pivotally rotated relative to the main frame section, such that the first wing section and the second wing section are arranged generally above the main frame section.

7. The agricultural implement of claim 1, wherein each of the first wing section and the second wing section includes a front rod extending laterally thereacross adjacent to the front end thereof, and wherein each of the pair of stabilizer wheels is attached to the respective front rod adjacent to an outer edge thereof.

8. An agricultural implement comprising:
a floating hitch;
a frame pivotally coupled to the floating hitch and having a front end and a back end;
a plurality of main lift wheels coupled to the frame adjacent to the back end by a main adjustment mechanism, wherein the main adjustment mechanism is configured to control a vertical distance between the frame and the plurality of main lift wheels;
a pair of front wheels coupled to the main frame section adjacent to the front end thereof, wherein the pair of front wheels are coupled to the main adjustment mechanism for vertical adjustment therewith; and
a pair of stabilizer wheels coupled to the frame by a stabilizer adjustment mechanism, wherein the stabilizer adjustment mechanism is configured to control a vertical distance between the pair of stabilizer wheels and the frame, and
wherein the stabilizer adjustment mechanism is functionally isolated from the main adjustment mechanism.

9. The agricultural implement of claim 8, wherein the frame comprises:
a main frame section pivotally coupled to the floating hitch at the front end thereof;
a first wing section pivotally coupled to one side of the main frame section; and
a second wing section pivotally coupled to another side of the main frame section opposite the first wing section.

10. The agricultural implement of claim 9, wherein the frame is configured to selectively transition between a working position and a transport position where the frame defines a reduced lateral footprint.

11. The agricultural implement of claim 10, wherein when the frame is in the transport position, the first wing section and the second wing section are pivotally rotated relative to the main frame section, such that the first wing section and the second wing section are arranged generally above the main frame section.

12. The agricultural implement of claim 9, wherein each of the first wing section and the second wing section includes a front rod extending laterally thereacross adjacent to the front end thereof, and wherein each of the pair of stabilizer wheels is attached to the respective front rod adjacent to an outer edge thereof.

13. The agricultural implement of claim 8, wherein the vertical distance between the pair of stabilizer wheels and the frame is adjustable independent of the vertical distance between the frame and the plurality of main lift wheels.

14. The agricultural implement of claim 8, wherein the main adjustment mechanism is configured to selectively move the frame between a raised position and a lowered position.

15. The agricultural implement of claim 14, wherein a transition between the raised position and the lowered position is configured to bring the pair of stabilizer wheels out of and into engagement with ground on which the agricultural implement is configured to travel.

16. An agricultural implement comprising:
a floating hitch;
a frame pivotally coupled to the floating hitch and having a front end and a back end, wherein the frame is vertically movable between a raised position and a lowered position via a main adjustment mechanism;
a plurality of main lift wheels coupled to the frame adjacent to the back end by the main adjustment mechanism;
a pair of front wheels coupled to the main frame section adjacent to the front end thereof, wherein the pair of front wheels are coupled to the main adjustment mechanism; and
a pair of stabilizer wheels coupled to the frame by a stabilizer adjustment mechanism, wherein the stabilizer adjustment mechanism is configured to control a vertical distance between the pair of stabilizer wheels and the frame, and
wherein the vertical distance between the pair of stabilizer wheels and the frame is adjustable independent of the vertical movement of the frame between the raised position and the lowered position.

17. The agricultural implement of claim 16, wherein the frame comprises:
a main frame section pivotally coupled to the floating hitch at the front end thereof;
a first wing section pivotally coupled to one side of the main frame section; and
a second wing section pivotally coupled to another side of the main frame section opposite the first wing section.

18. The agricultural implement of claim 17, wherein the frame is configured to selectively transition between a working position and a transport position where the frame defines a reduced lateral footprint.

19. The agricultural implement of claim 17, wherein each of the first wing section and the second wing section includes a front rod extending laterally thereacross adjacent to the front end thereof, and wherein each of the pair of stabilizer wheels is attached to the respective front rod adjacent to an outer edge thereof.

20. The agricultural implement of claim 16, wherein a transition between the raised position and the lowered position is configured to bring the pair of stabilizer wheels out of and into engagement with ground on which the agricultural implement is configured to travel.
